(19) United States
(12) Patent Application Publication
(10) Pub. No.: US 2008/0067707 A1
(43) Pub. Date: Mar. 20, 2008

(54) METHOD AND PRESS FOR THE PRODUCTION OF MOLDING ELEMENTS

(75) Inventors: Klaus Muller, Welschbillig (DE); Ralph Lutz, Lorscheid (DE); Alfred Kaiser, Fohren (DE); Robert Kremer, Aachen (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: LAEIS GMBH, Wecker (LU)

(21) Appl. No.: 11/854,813

(22) Filed: Sep. 13, 2007

(30) Foreign Application Priority Data
Sep. 14, 2006 (DE) 102006043270.3

(51) Int. Cl. B28B 13/02; B30B 11/00

(52) U.S. Cl. 264/40.4; 264/40.5; 425/110; 425/159

(57) ABSTRACT

In a method for producing molding elements having a predetermined thickness profile, in which a filling tool of a filling device is filled with a molding material and the molding material is released in the direction of gravity from the filling tool into a pressing mold of a press, the molding material is held in the filling tool by means of suction, and its release into the pressing mold is effected by a reduction, particularly a deactivation, of the suction force.

### CROSS REFERENCE TO RELATED APPLICATIONS

The present application claims international priority under 35 U.S.C. § 119 to co-pending German Patent Application No. 102006043270.3 filed Sep. 14, 2006, entitled “Verfahren und Presse zum Herstellen von Formkoerpern,” the entire content and disclosure of which is hereby incorporated by reference in its entirety.

### TECHNICAL FIELD

The invention concerns a method for producing molded elements with a predetermined thickness profile, in which a filling tool of a filling device is filled with a molding material, and the molding material released in the direction of gravity from the filling tool into a pressing mold of a press, and a press for implementing such methods.

### BACKGROUND

Molding methods and presses are of course of the prior art. The filling tool is used to release the molding material into the pressing mold in the most precise quantity possible to form the molded element with the predetermined thickness profile. The purpose is to achieve the most homogeneous possible thickness of the molded element in the subsequent molding operation.

On the other hand, the loading of the pressing mold with the molding material should occur quickly, i.e., within the molding cycle, and should be as easy as possible to handle. Thus, for example, the filling tool is filled with the correct quantity of the molding material, moved across the pressing mold, and the molding material is emptied into the pressing mold. In addition, the filling tool can have a base plate, which can be removed in a horizontal direction, which prevents the molding material from being released, and through the removal of which causes the release of the molding material into the pressing mold.

In such methods of the prior art, however, the consistent thickness of the pressed molded element has not been found to be completely satisfactory, even with simple, regular thickness profiles, and certainly with more complex thickness profiles.

### BRIEF DESCRIPTION OF THE DRAWINGS

Embodiments of the invention are explained below with reference to the drawings, to which reference is made with respect to all details that are material to the embodiments.

FIG. 1 is a schematic representation of a press according to the invention.

FIG. 2 is a schematic representation of a filling device of a press according to the invention.

FIG. 3 is a top view of a tile that can be produced with a method according to the invention, and particularly well with an advantageous embodiment of the method according to the invention.

FIG. 4 is a schematic representation of the arrangement of the dividers in a filling tool that can be used in the manufacturing process for producing the tile shown in FIG. 3.

### DETAILED DESCRIPTION OF EMBODIMENTS OF THE INVENTION

In light of the foregoing problems, the objective of the invention is to provide a method with which a more homogeneous distribution of thickness in the pressed molded element is achieved from the molding operation.

For the reasons evident below, the aforementioned objective is particularly important for molded elements with irregular thickness profiles and/or complex geometries, but is also more difficult to achieve.

This is because molded elements that have complex geometries present special challenges to the molding technology used to manufacture such products. This applies particularly for products that have pronounced and, above all, irregular transitions between different thicknesses with respect to the pressing surface, i.e., sudden changes in molded element height in a cutting plane parallel to the pressing surface. One example of a product with such a complex thickness profile is the typical Central European roof tile. These roof tiles, which have a total surface of approximately 400×300 millimeter² (mm²), have a typical body thickness of 12 mm. They have a number of lug folds, longitudinal folds, and/or transverse folds, however, in which the molded element is more than twice as thick. The manufacture of such products is made even more difficult by the fact that the height of the folds, lugs, etc., can have practically any value between zero and a maximum value. When implementing methods for the manufacture of such products, care must be taken that given consistent surface elements in the top view (pressing surface), very strongly fluctuating quantities of molding material are supplied in order to achieve a consistent thickness. If it is not possible to supply the necessary molding material in each surface element in accordance with requirements, this can result in insufficient compression in the areas of greatest thickness and overpressing in thinner areas. This could impair the product's properties. In particular, this may lead to mechanical weakness (lower bending or tensile strength, or lower resistance to breakage), greater porosity in the thinner areas of the molded element, and an associated decrease in ability to withstand alternating freezing and thawing, as well as an increased tendency to deformation and the formation of cracks during the drying and firing process. Moreover, a defective distribution of the molding material may result in an irregular application of glazes, engobes, and other coatings, and thus conspicuous optical irregularities as well as inferior surface properties in the final product.

For this reason, methods for producing molded elements with a predetermined thickness profile must ensure that the molding material required for each surface unit is supplied to this surface unit as precisely as possible. This applies particularly in the manufacture of molded elements with complex geometries using uniaxial presses. The size of the surface units to which different quantities of molding material must be supplied depends largely on the size and geometry of the molded element itself and the properties of the molding material. Of particular importance in this context is the ability of the molding material to enable a shifting of material transverse to the direction of compression by means of plastic flow under pressure. In the case of the roof tiles mentioned above, the size of the surface units or reference surface elements under consideration is on the order of approximately 10 centimeter² (cm²) to approximately 100 cm².

When implementing methods to produce such molded elements, it must also be noted that the cycle time of the press and thus the production capacity must not be excessively affected. In addition, appropriate methods and equipment for multiple molds must also be usable, with which a number of products having a predetermined thickness profile can be manufactured simultaneously.

In press molding with a uniaxial press for the production of molded elements, the mold is generally filled volumetrically, regardless of whether the press is designed for single-sided or two-sided molding. In this process, the cavity and/or pressing mold is filled by moving a filling tool over the pressing mold, with the filling tool containing a surplus of the molding material relative to the total material required for the respective molding operation. By lowering the bottom die or raising the press's molding frame on the sides of the press molding to an adjustable filling position, it is possible to define the volume that will be filled by the material being transferred from the filling device. The transfer may be effected both through ejection into the already opened cavity and/or pressing mold, as well as through “suctioning” filling, in which the cavity and/or pressing mold is opened only when the filling device is positioned above the pressing mold. Excess material is skimmed off when the filling device is moved in reverse such that the top surface of the molding material loaded into the pressing mold aligns with the molding frame and creates an even upper surface of the molding material.

When implementing these methods of the prior art, it is possible to achieve different filling heights in the pressing mold and thus different molding material quantities in side-by-side pressing mold segments by changing the filling height through a controlled movement of the bottom die and/or the molding frame up or down while the filling slide is moved in reverse. This is described as “wedge” filling. Such a filling of the pressing mold, however, only permits a constant change of the filling height in the direction of the filling device's axis of travel. The distribution of molding material in the pressing mold necessary for the production of molded elements with a complex thickness profile, such as roof tiles, cannot be achieved with such methods. For the production of such molded elements, it has already been proposed to subdivide the bottom die of the pressing mold into a number of side-by-side segments, which can be moved to different heights prior to or during the filling operation, thus forming a height contour in the lower area of the pressing mold, while the surface of the molding material loaded into the molding form is skimmed off to form an even surface, as in traditional methods. Presses with bottom dies subdivided into a number of segments are typically used in the manufacture of large-format, high-value molded elements, such as the production of fireproof slide plates for steel manufacturing. Because of the necessary “active” elements in the mold, however, the mold is very complex and expensive. Moreover, the production of molded elements with a complex thickness profile is frequently observed to result in excessive stress and in some cases damage to the press. This is the case regardless of whether a press with “active” mold elements or a traditional press is used.

Given these problems in the state of the art, another objective of the invention in a greater scope is to provide a method for manufacturing molded elements with a predetermined, particularly nonuniform, thickness profile, which can be implemented while avoiding damage to the press and ensuring predetermined product properties with structurally simple presses, as well as to provide corresponding presses.

According to the invention, the aforementioned objective is achieved through a refinement of the method of the prior art, which is essentially characterized by the fact that the molding material is held in the filling tool by means of suction, and its release into the pressing mold is effected through a reduction of the suction force.

This solution is based upon the amazing finding that with the mechanism according to the invention for the transfer of the molding material from the filling tool into the pressing mold, a more orderly transfer is made possible, thus improving the degree of homogeneity in the thickness of the molded element pressed from the molding material.

The mechanism according to the invention for transfer of the molding material is also advantageous insofar as no mechanical opening of the filling surface needs to be undertaken, such as the aforementioned pulling back of the filling device's base plate.

Instead, only a stream of air through the molding material caused by the suction prevents the molding material from falling down. The necessary suction force and/or the creation of a pressure differential necessary for the suction can be easily produced, e.g., by means of a pump (e.g., a vacuum pump) of any design. A pressure differential of approximately 200 to 300 millibar (mbar) is sufficient in most applications to hold the molding material firmly in the filling tool by means of the resulting flow-through of air. The material can be allowed to fall very easily by reducing the suction force, for example by deactivating one of the pumps that generate the suction force.

The method according to the invention can be applied with particular advantage if at least two side-by-side segments of the pressing mold placed vertical to the direction of gravity are loaded with different molding material quantities in accordance with the predetermined thickness profile, i.e., particularly in the case of irregular thickness profiles caused by complex geometries in a molded element. In addition, the side-by-side segments of the filling tool corresponding to the side-by-side segments of the pressing mold are filled with different molding material quantities corresponding to the predetermined thickness profile.

This advantageous embodiment of the method is based upon the simple recognition that the distribution of the molding material necessary in the pressing mold can be ensured even if this distribution does not take place in the pressing mold itself, but instead occurs previously in the filling tool, because the transfer of the molding material according to the invention from the filling tool into the pressing mold means that there is no longer any concern of a notable change in the distribution of the molding material. In the implementation of this embodiment, therefore, the otherwise necessary use of bottom dies of the pressing mold subdivided into multiple side-by-side segments can be omitted, and the press needed for the implementation of such a method is significantly simplified.

Furthermore, a high degree of operational reliability can be achieved in the implementation of such methods, because neither an unequal, particularly asymmetrical loading of the pressing mold, nor an excessive loading of movable segments of the bottom die of the pressing mold is a concern. An asymmetrical loading of the pressing mold can be avoided because the corresponding filling of the filling tool and transfer of the molding material according to the invention from the filling tool into the pressing mold already ensures a distribution of the molding material in the pressing mold such that no unequal or asymmetrical loading of the pressing mold occurs during the production of molded parts with complex thickness profiles. Moreover, when implementing this embodiment of the method, the use of movable segments of the pressing mold's bottom die loaded with a high pressing pressure can be avoided, which also contributes to an increase in operational reliability.

In a preferred embodiment of the method, the reduction of suction force in the individual side-by-side segments of the filling tool occurs at least partially with a time delay. Thus, for example, segments in which there is a significantly larger quantity of molding material than in other segments can be released earlier than these other segments, which enables a more even filling of the pressing mold.

In particular, the method provides for the time delay to be controlled depending upon the expected time required by the molding material quantity loaded in the respective segment of the filling tool to fall into the respective corresponding segment of the pressing mold. Thus, in continuation of the aforementioned advantage, a synchronous filling of the pressing mold with the molding material can be achieved.

According to a particularly preferred embodiment of the method, the molding tool is filled through the same opening as the release of the molding material into the pressing mold. Thus the side of the molding tool facing away from the pressing mold has enough room for a structurally simple attachment of the suction mechanism.

In a particularly useful embodiment of the method, the filling tool is brought into the release orientation to be assumed for release of the molding material only after the filling operation, and the filling operation occurs with the filling tool having a filling orientation that is essentially rotated 180° respective to the release orientation, i.e., from above. This takes an additional work step into account in order to enable the simple filling operation from above. The associated time expenditure is reasonable, however, because the operation can be performed outside of the work cycle of the press.

According to another particularly preferred embodiment of the method, the molding material is released from a filling container into the filling tool in such a way that the top surface of the molding material loaded into the filling tool respective to the filling orientation aligns with the upper rim of the filling tool respective to the filling orientation, wherein the molding material quantities in the side-by-side segments of the filling tool result automatically based upon the respective level of the base of the filling tool. Thus it is possible to advantageously achieve a situation in which no particular diligence is required when filling the filling tool. In particular, it is sufficient to simply pour precisely the correct total molding material into the filling tool.

Another useful aspect in this respect is that the filling container is pulled from the filling tool in a horizontal direction in order to adjust the filling level. Thus there is also no need to adhere to a precise total of molding material, and even an excess of molding material can be loaded into the filling tool because the precise amount of excess material is subsequently skimmed off.

In a further embodiment of the method different from the aforementioned filling operation, the pressing tool can be filled, particularly with multilayered molding material, so that the filling tool bites into a prepared molding material structure in a release orientation suitable for release of the molding material. This means that the filling tool is not rotated and filled from above, but rather from below. For this purpose, the filling tool, which is particularly advantageously in the form of a cutting box, can be set upon and/or bite into a molding material with an already prepared thickness, following which the suction is activated and the filling tool together with the molding material can be moved to the release position. This type of method is particularly advantageous for manufacturing molded elements with multilayer structures, compared to the typical laborious top-filling methods for multilayer structures.

As shown by the aforementioned explanation of the method according to the invention, a press for implementing this method with a pressing mold designed to receive molding material and a filling tool designed to fill the pressing mold, and which can be operated to release the molding material into the pressing mold in the direction of gravity, is distinguished by the fact that the filling device can be operated by means of a suction device to hold the molding material in the filling tool by means of suction exerted upon the molding material. Possible suction devices include, for example, a pump or a number of pumps that is/are connected with the filling device in a suitable manner. Any common vacuum pump is suitable, so long as it can create the pressure differential between the outside and inside of the molding material as required for the suction force.

In a particularly preferred embodiment, at least two segments of the pressing mold arranged side-by-side in an orientation perpendicular to the direction of gravity can be loaded by the filling device with different molding material quantities in accordance with the predetermined thickness profile of a molded element to be manufactured, and the filling device is designed for filling the side-by-side segments of the filling tool corresponding to the side-by-side segments of the pressing mold with different molding material quantities in accordance with the predetermined thickness profile in a filling station of the filling device arranged horizontally at a distance next to the pressing mold.

With a press designed in this manner, it is possible, as explained above, to achieve outstanding production of molded elements, including those with very irregular thickness profiles and/or complex structures.

In a useful embodiment of the press, the filling tool has a housing in which the segments are arranged side-by-side and separated from one another by preferably somewhat vertical dividers. This can therefore prevent an undesirable mingling across segments of the molding material quantities assigned to the segments.

In a particularly preferred embodiment of the press, the filling tool has a receiving area arranged underneath respective to the release orientation that is suitable for receiving the molding material and limited above by an air-permeable base area. This means that the receiving area constitutes the area of the filling tool corresponding to the classical filling shoe. The air-permeable base area enables a flow of air through the molding material taken into the receiving area on the other side of the base area.

In a particularly preferred embodiment, the base area is set at a level such that the molding material quantities received in the respective segments correspond to the molding material quantities to be loaded in the respective arranged segments of the pressing mold when the receiving area is filled up to the lower rim of the molding tool respective to the release orientation. This is advantageous in that the molding material quantities necessary for the segments of the pressing mold will automatically be allocated correctly. Thus, based upon one's perspective, the setting of the level of the base area corresponds to the thickness profile of the molded element to be produced and/or of the mirror-inverted thickness profile.

In a useful embodiment, the base area has a sieve with a mesh aperture that is essentially impermeable for the molding material. This can prevent the molding material from entering into the suction mechanism, which would impair its functioning.

In this regard, special provision is made that the mesh aperture of the sieve is in the range of 0.1 to 200 micrometers (μm), preferably 1 to 50 μm and particularly 5 to 20 μm.

According to a particularly useful embodiment, the base area has a perforated metal plate. The perforated metal plate should be strong enough to perform the necessary supporting function when the filling tool is in the filling orientation. The perforated metal plate is also a simple and cost-effective solution for the base area. The holes serve to allow the flow-through of air (see above), but they must not perform any retaining function for the molding material particles in the event that a sieve is used.

According to another particularly useful embodiment, the base area/perforated metal plate is in the form of a freely contoured surface. This permits the true-to-form reproduction of almost any thickness profile of the molded elements being produced, and thus the achievement of an optimal pre-allocation of the necessary molding material quantities.

According to a useful embodiment, the receiving area has a filling grid that subdivides the receiving area/the segments at least in part and horizontally. This therefore provides guidance for the falling molding material on an even smaller scale, so that they mix together even less when falling.

In a useful embodiment of the press, a vacuum area located above the base area respective to the release orientation is provided in the filling tool, and is connected to the suction device in order to produce the pressure differential relative to the atmospheric pressure as necessary for suction. This creates a suitable transition space between the receiving area and the suction device, by means of which a variety of air passages providing for equal suction is created through the base area, while simultaneously allowing a small number of air lines to the suction device.

In a particularly useful embodiment, the creation of the pressure differential in individual segments of the vacuum area can be controlled separately, and a control device is provided for its control. This is naturally a prerequisite for the aforementioned advantageous, time-delayed control of the individual segments of the vacuum area (vacuum chambers). The separate control capability is made possible by the fact that air is drawn from each of the vacuum chambers through a separate line, and the individual lines can be restricted and/or interrupted by means of the respective valves.

According to an advantageous embodiment, the control unit is designed for calculation of the time of fall of the molding material from the individual segments of the filling tool into the corresponding segments of the pressing mold. Information regarding the structure, the thickness profile of the pressing mold, and/or the respective filling height of the filling tool can be made available to the control unit for this purpose.

According to a particularly useful and practical embodiment, a filling station for filling the filling tool is also provided for the press, with a positioning device for positioning the filling tool for the filling in a filling orientation essentially rotated 180° respective to the release orientation, and for positioning the filling tool in the release orientation for the next release of the molding material. Thus the molding tool, as shown by the aforementioned explanation of the method claims, can be easily filled and moved across the pressing mold in the typical manner.

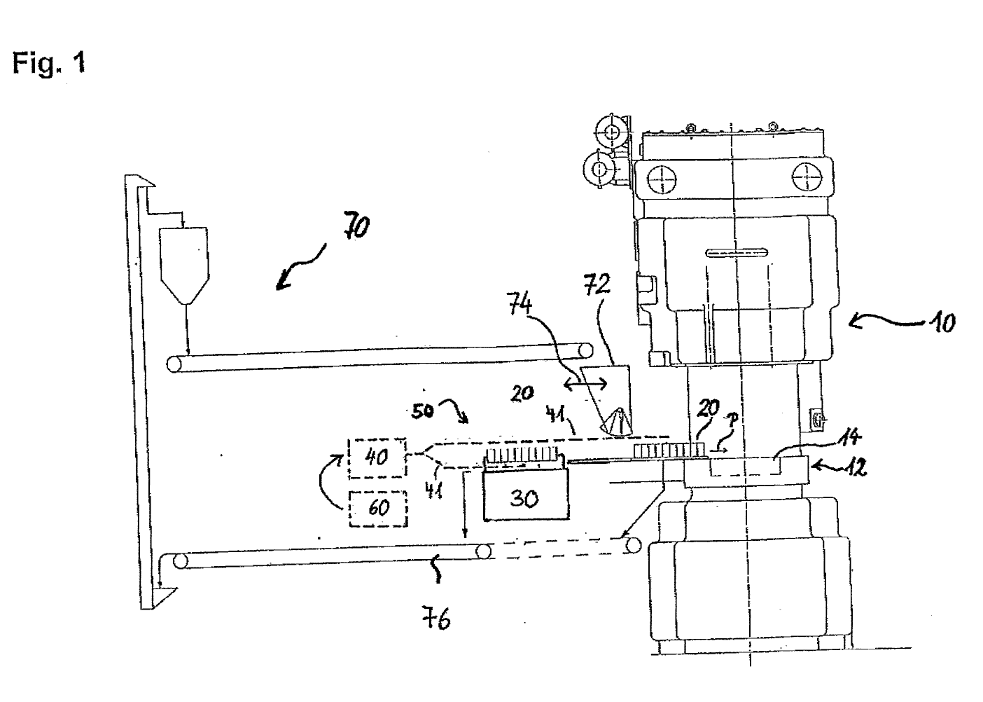

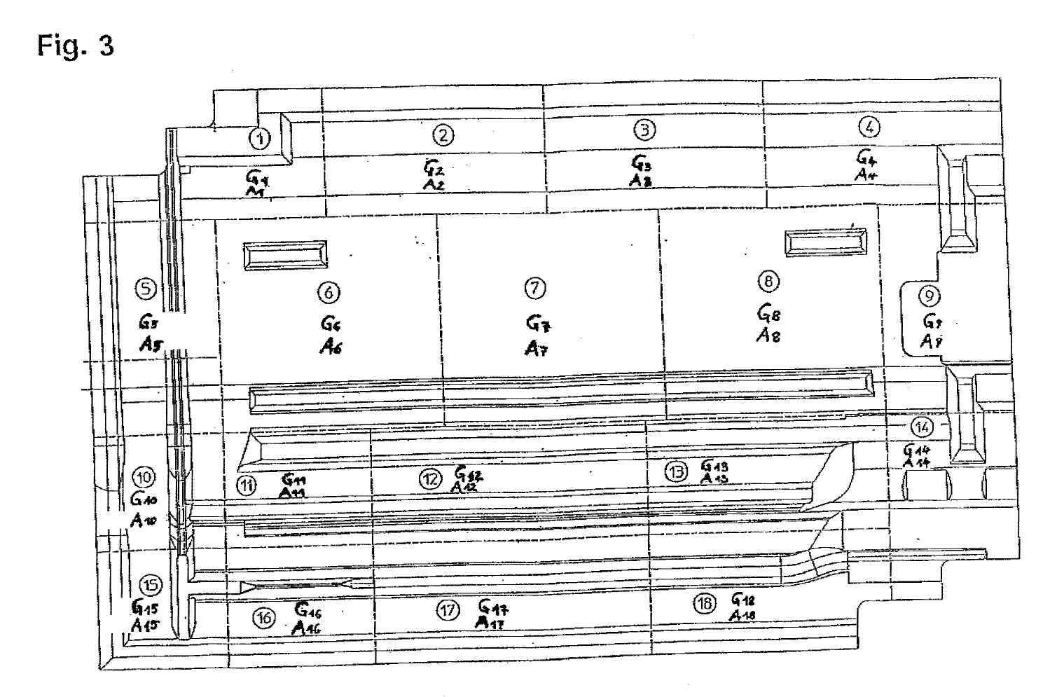

The press according to the invention as shown in FIG. 1 (e.g., for the manufacture of the tiles shown in FIG. 3) comprises a bottom die 12, a filling device 20, a filling station designated overall as 50, and a conveyor configuration for the molding material designated overall as 70. A pressing mold 14 is formed in lower tool 12, which with the help of filling tool 20 can be filled with molding material supplied by conveyor device 70. A filling container 72 can be moved back and forth horizontally for this purpose, as indicated by double arrow 74.

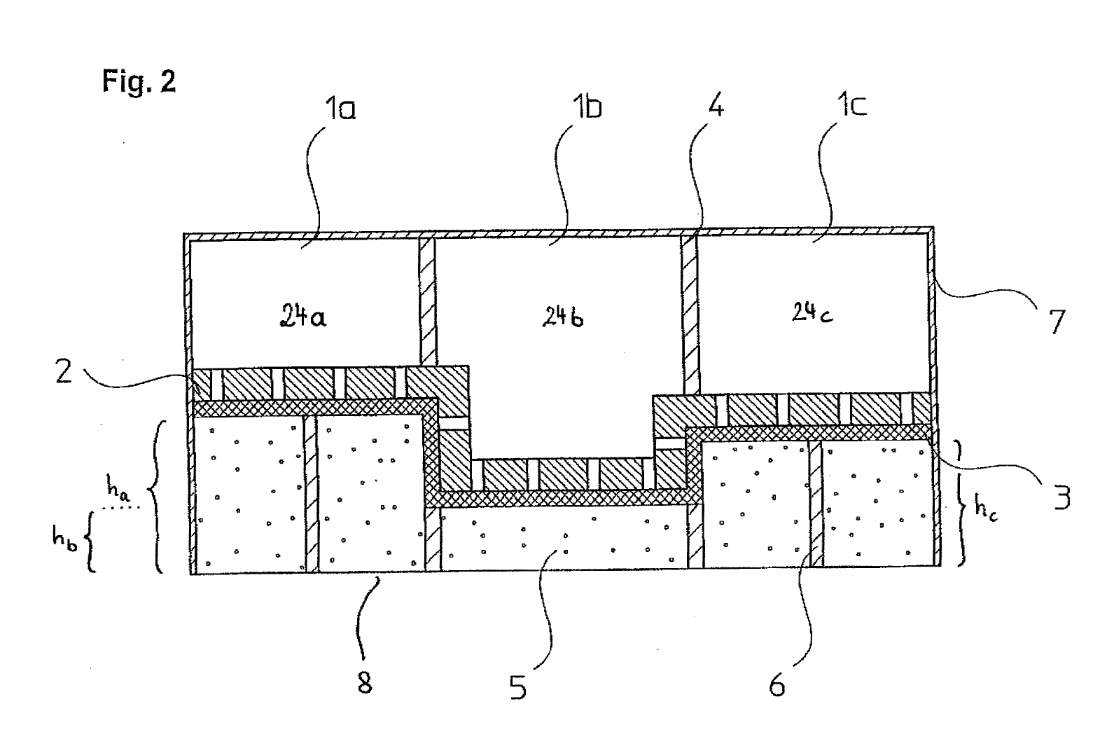

Filling tool 20 is loaded in its filling orientation in filling station 50 at a distance next to pressing mold 14 with the molding material supplied by conveyor configuration 70. A pump 40 is then controlled by control unit 60 to create a pressure differential between opening 8 and the intermediate bottom of filling tool 20 (see FIG. 2). In addition, pump 40 is connected with filling tool 20 by means of the lines 41 indicated by dashed lines in FIG. 1. Filling tool 20 can now be rotated 180° into the release position by positioning device 30 once the molding material has been suctioned. The molding material is prevented from falling by being suctioned onto filling tool 20.

Filling tool 20 is then moved into release orientation over pressing mold 14 and the molding material loaded into filling tool 20 is released in the direction of gravity into pressing mold 14 by deactivating the suction force, as explained below in greater detail, so that the molding material falls as usual under the influence of gravity into the pressing mold.

Molding tool 20 of the press according to the invention is described below in greater detail based upon FIG. 2. FIG. 2 is a schematic sectional view that illustrates the suction mechanism for suctioning the molding material.

Filling tool 20 has a housing 7 as a frame, and in the release position shown in FIG. 2, it is open on its bottom surface 8, shown here in the sectional view as solid line 8. The interior of housing 7 is shown in both horizontal and vertical view. The primary subdivision for the suction mechanism according to the invention is achieved by means of an intermediate bottom consisting of perforated metal plate 2 and sieve 3. As shown in FIG. 2, the intermediate bottom need not be on a uniform level across the entire filling tool 20, but can instead have different levels for each segment (or can be entirely in the form of a freely contoured surface, see below).

The intermediate bottom separates the interior of housing 7 into a lower receiving area for receiving molding material 5 and an upper vacuum area 1. If one mentally inverts FIG. 2 (filling orientation), then the receiving area can be filled with molding material, for example by having a filling container 72 (FIG. 1) load the receiving area with molding material and then skim off the molding material protruding above surface 8. The volume of receiving chamber 8 should therefore essentially correspond to the total molding material quantity needed to produce the molded element.

With the method according to the invention, it is now possible to suction molding material 5 loaded into the receiving area in the direction of the intermediate bottom, so that despite the effect of gravity, loaded molding material 5 is held by filling tool 20 even after positioning in the release orientation shown in FIG. 2. A pump draws air from vacuum area 1 for this purpose through lines not shown and openings not shown, e.g., in the surface of housing 7, that face the vacuum area. A pressure differential is created between vacuum area 1 and the receiving area, because although air can flow out of the exterior chamber and into the vacuum area through molding material 5 loaded in the receiving area, sieve 3, and the openings in perforated metal plate 2, molding material 5 creates resistance to the airflow.

So long as pump 40 is operated, an equilibrium value is therefore created for the pressure differential, which in this case is approximately 200 to 300 mbar. Because of the continuous stream of air, which penetrates molding material 5, molding material 5 is held against the effect of gravity in receiving area 8.

The mesh aperture of sieve 3 in this sample embodiment is approximately 10 μm, but can be varied in principle, so long as it is ensured that basically no molding material particles can penetrate through sieve 3.

In the simplest case, molding material 5 can be released from the receiving chamber by deactivating the pump. The pressure differential is then reduced almost immediately, and molding material 5 falls as desired from the receiving chamber into underlying pressing mold 14 (see FIG. 1). Alternatively, the suction power of the pump can also be reduced to zero at a predetermined rate. The pressure differential is then reduced at a slower pace, and molding material 5 gradually falls into underlying pressing mold 14.

The subdivision between the vertical dividers 4 is described next. These dividers define segments or chambers 24 in housing 7, which are allocated to the corresponding segments of pressing mold 14, or are formed in order to enable a suitable allocation of the segments. Perforated metal plate 2, which serves as the primary body of the intermediate bottom, can now be formed so that at least partially differing filling heights of the corresponding segment of the receiving area result for the different depicted segments 24a, b, and c. FIG. 2 shows three different filling heights hₐ, h_{b}, und h_{c}. The heights h have been selected so that the product of the height and the corresponding horizontal cross-section of the corresponding segment results in a molding material volume that correlates with the molding material quantity required in the corresponding segment of pressing mold 14 in accordance with a predetermined thickness profile of the molded element to be produced.

In short, the setting of the level of the intermediate bottom is selected so that the different molding material quantity required at each of the individual points of the pressing mold have been appropriately supplied in advance to filling tool 20.

FIG. 2 shows the intermediate bottom having several levels. It is also possible, however, to create perforated metal plate 2 in the shape of a freely contoured surface that in its central aspects continuously reproduces a correspondingly complex thickness profile of the molded element to be produced (curved surface). Thus the required molding material is appropriately supplied on an even smaller scale.

If the filling heights h differ greatly, particularly if they differ abruptly, an intermixing that reduces effectiveness may occur if the suction force is reduced across the entire molding tool, because due to different times of fall of different molding material areas, there is the possibility that the previously selected suitable molding material quantity distribution will change as a result of horizontal molding material particle movement when molding material 5 impacts pressing mold 14. In order to minimize the effects of this problem, the molding material quantities 5 contained in the individual segments 24 can be released from molding tool 20 in a time-controlled manner. To accomplish this, the individual vacuum chambers Ia, b, and c and/or the suction of air from these chambers merely need to be controlled separately. For this purpose, a portion of the segments 24 or even all of the segments 24 can have a line to pump 40 that is at least separately interruptible.

As already explained above, a high-precision control of the falling of molding material 5 from a segment 24 of molding tool 20 can be achieved through a targeted, controlled reduction of suction force by means of effective reduction of suction power for the corresponding segment 24.

As also visible in FIG. 2, the portions of the receiving area allocated to the segments can be further subdivided by a filling grid 6. This will at least further restrict any disruptive horizontal impulses caused by falling molding material particles.

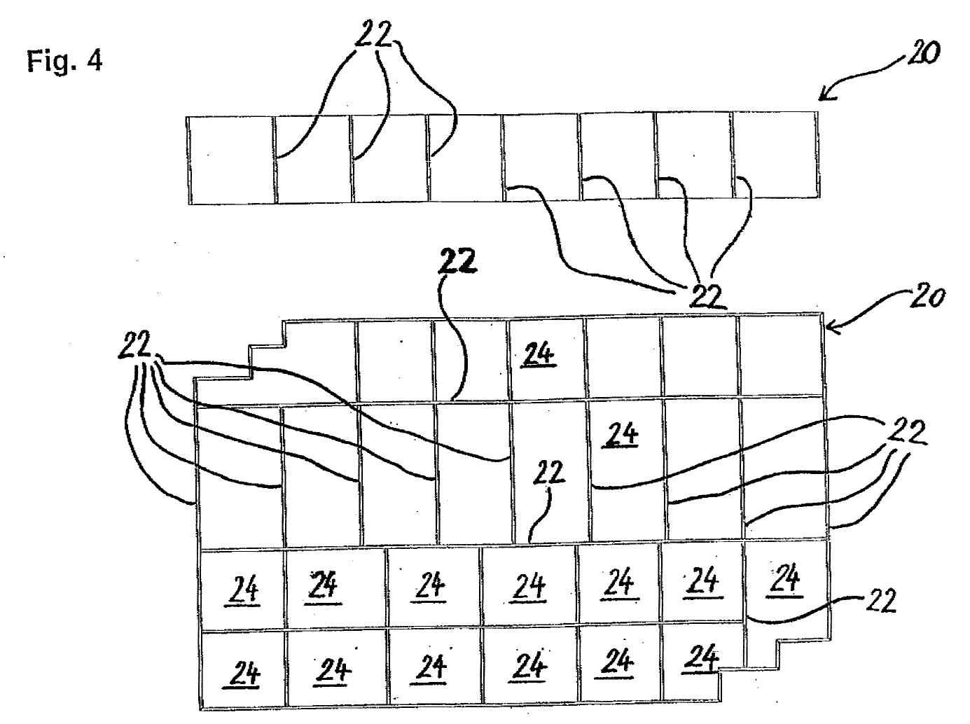

The allocation of the corresponding segments of pressing mold 14 and filling tool 20 is described below based upon FIGS. 3 and 4.

According to FIG. 3, a typical molded element to be produced is subdivided into individual side-by-side segments with predetermined surfaces, wherein a value for the molding material weight is determined for each of the segments based upon the profile of the molded element and the surfaces. In FIG. 3, a tile is subdivided into a total of 18 segments with areas A₁ to A₁₈, with a molding material weight of G₁ through G₁₈ allocated to each area.

FIG. 4 shows a schematic representation of the arrangement of dividers 22 (corresponding to the dividers 4 in FIG. 2) in a filling tool 20, which is adapted to the subdivision of the tile explained in FIG. 3. Here filling tool 20 is also structured as explained schematically in FIG. 2, although FIG. 4 (with the suction mechanism according to the invention not shown) is intended merely to provide a realistic image of a possible and/or necessary subdivision of molded element 20.

The level setting of the intermediate bottom (perforated metal plate 2) in this example is established by the filling material weight G₁ to G₁₈ required for the individual segments of the tile. Following appropriate positioning of filling tool 20 in the filling orientation, the molding material is loaded with a filling container (72 in FIG. 1) filled with an excess of molding material into the individual segments of filling tool 20, and excess material is skimmed off from the upper rim (in the filling orientation) of the filling tool through horizontal movement of the filling container respective to the filling tool. The skimmed-off material is fed back to conveyor configuration 70 with the help of a conveyor belt 76, and can be conveyed again to filling station 50 for the production of subsequent molded parts and/or tiles.

For precise filling of the pressing mold, it is necessary that the selected geometries of the filling tool still permit a problem-free emptying into the pressing mold. In the case of critical geometries, this can be supported by means of rounded edges and/or corners of the individual chambers of the filling tool, vibration devices, or similar devices.

The press according to the invention is also particularly suitable for the production of molded elements with layered structures consisting of two or more layers of different initial molding material. The traditional filling of filling tools is particularly cumbersome when different molding materials are used. By contrast, the method according to the invention obviates the need to load the different materials into the filling tool in layers from above. Instead, they can be prepared outside of the pressing mold in the form in which they will then also be present in the pressing mold. A filling tool equipped with the suction mechanism according to the invention can then pick up a section of the prepared molding material layers that are positioned in close contact with one another, like a cookie-cutter, whereupon the suction mechanism is put into operation. The filling tool can then be moved across the pressing mold as usual, and the molding material with the layered structure released into the pressing mold.

In such a procedure, the filling tool can also be suitably formed as a cutting box, i.e., the edges of the side walls of housing 7 facing the opening surface 8 (in FIG. 2), the dividers 4, and/or the filling grid 6 can be in the form of cutting edges.

The embodiments of the invention explained based upon the figures are intended only for explanation, and do not restrict the scope of the invention. On the contrary, the features of the invention disclosed in the aforementioned description as well as in the claims can be essential, both individually as well as in any combination, for the realization of the invention in its various embodiments.

1-21. (canceled)

22. A method for producing a molded element having a predetermined thickness profile, comprising:
filling a filling tool with a molding material;
holding the molding material within the filling tool by a suction force; and
releasing the molding material in the direction of gravity from the filling tool into a pressing mold by reducing the suction force.

23. The method of claim 22, wherein said releasing the molding material comprises deactivating the suction force.

24. The method of claim 22, wherein the pressing mold includes at least two first segments arranged side-by-side in an orientation perpendicular to the direction of gravity, the pressing mold being configured to be loaded with different quantities of the molding material based at least in part on a predetermined thickness profile of the molded element.

25. The method of claim 24, wherein the filling tool includes at least two second segments of the filling tool corresponding with the at least two first segments, the at least two second segments being configured to be loaded with different quantities of the molding material based at least in part on the predetermined thickness profile, and wherein said filling the filling tool comprises filling the at least two second segments with different quantities of the molding material quantities based at least in part on the predetermined thickness profile.

26. The method of claim 25, further comprising placing the filling tool into a release orientation for releasing the molding material after said filling, and wherein said filling the filling tool comprises filling the filling tool while the filling tool is in a filling orientation, the filling orientation being substantially 180° above the release orientation.

27. The method of claim 26, wherein said filling the filling tool comprises releasing the molding material from a filling container to fill the filling tool so that a top surface of the molding material respective to the filling orientation aligns with an upper rim of the filling tool, and wherein the at least two second segments are filled with quantities of the molding material based at least in part on a configuration of a base of the filling tool.

28. The method of claim 25, wherein said releasing the molding material comprises reducing the suction force, at least in part, in the at least two second segments after a time delay.

29. The method of claim 28, further comprising controlling the time delay based at least in part on an anticipated time for the molding material loaded into at least one of the second segments to fall into the corresponding at least one first segment.

30. The method of claim 22, wherein said filling the filling tool comprises filling the filling tool through an opening, and wherein said releasing the molding material comprises releasing the molding material through the opening.

31. The method of claim 22, wherein said filling the filling tool comprises filling the filling tool with a multilayer molding material while the filling tool is in a release orientation, and wherein the filling tool is configured to bite into the multilayer molding material.

32. A press for producing a molded element, comprising:
a pressing mold configured to receive a molding material;
a filling tool configured to load the pressing mold with the molding material by controllably releasing the molding material in a direction of gravity into the pressing mold; and
a suction device configured to releasably hold the molding material in the filling tool.

33. The press of claim 32, wherein the pressing mold includes at least two first segments arranged side-by-side in an orientation perpendicular to the direction of gravity, the at least two first segments being configured to be loaded with different quantities of the molding material based at least in part on a predetermined thickness profile of the molding element.

34. The press of claim 33, wherein the filling tool includes at least two second segments of the filling tool corresponding with the at least two first segments, the at least two second segments being configured to be loaded with different quantities of the molding material based at least in part on the predetermined thickness profile.

35. The press of claim 34, further comprising a filling station disposed horizontally to the pressing mold and configured to load the at least two second segments with different quantities of the molding material based at least in part on the predetermined thickness profile.

36. The press of claim 35, wherein the filling station includes a positioning device configured to position the filling tool into a filling orientation for filling with the molding material, and further configured to position the filling tool into the release orientation for releasing the molding material, the filling orientation being oriented substantially 180° relative to the release orientation.

37. The press of claim 34, wherein the filling tool further includes a housing that defines, with substantially vertical dividers the corresponding at least two second segments.

38. The press of claim 34, wherein the filling tool further includes:
a receiving area configured to receive the molding material; and
an air-permeable base area disposed above the receiving area.

39. The press of claim 38, wherein the base area is configured so that a received quantity of the molding material by the at least two second segments corresponds to a required quantity of the molding material to be loaded in the corresponding at least two first segments when the receiving area is filled to a lower opening of the filling tool relative to a release orientation of the filling tool.

40. The press of claim 38, wherein the base area comprises a sieve including a mesh aperture, the mesh aperture being substantially impermeable to the molding material.

41. The press of claim 38, wherein the base area comprises a perforated metal plate.

42. The press of claim 38 wherein the base area has a freely contoured surface.

43. The press of claim 38, wherein the receiving area includes a filling grid configured to horizontally subdivide, at least in part, the receiving area.

44. The press of claim 38, further comprising a vacuum area disposed above the base area relative to a release orientation of the filling tool, the vacuum area being configured to create a pressure differential in the suction device relative to atmospheric pressure for releasably holding the molding material in the filling tool.

45. The press of claim 44, further comprising a control device configured to control the pressure differential in one or more individual segments of the vacuum area.

46. The press of claim 45, wherein the control device is configured to calculate a time required by the molding material to fall from the at least two second segments into the corresponding at least two first segments.
